(19) United States
(12) Patent Application Publication
(10) Pub. No.: US 2007/0080546 A1
(43) Pub. Date: Apr. 12, 2007

(54) Sideward clipping apparatus

(75) Inventor: Chin-Wen Chou, Taipei Hsien (TW)

Correspondence Address: BIRCH STEWART KOLASCH & BIRCH, PO BOX 747, FALLS CHURCH, VA, 22040-0747, US

(73) Assignee: ZIPPY TECHNOLOGY CORP.

(21) Appl. No.: 11/245,080

(22) Filed: Oct. 7, 2005

(51) Int. Cl. E05C 19/00

(52) U.S. Cl. 292/304

(57) ABSTRACT

A sideward clipping apparatus aims to clip and release an article through double-depressing actions in cyclic operations. It has a pawl which includes an upper clipping end and a lower clipping end to clip the article. The lower clipping end synchronously drives the upper clipping end through a coupling portion at an initial force receiving state to form a first fan type moving track. The lower clipping end is in contact with a sliding member and moved vertically to a second position under force to drive the upper clipping end to form a second fan type moving track. Thereby the upper clipping end and the lower clipping end form a clipping space on the second position to securely clip the article.

### FIELD OF THE INVENTION

The present invention relates to a clipping apparatus and particularly to a sideward clipping apparatus.

### BACKGROUND OF THE INVENTION

A clipping apparatus mainly aims to couple two elements together or release one of the two elements through a simple operation. It generally is adopted on doors or the like. For instance, the door of the operation panel of household appliances usually uses such an apparatus. The conventional clipping apparatus have many types and are operated in different ways. They mostly adopt depressing operation. A first depressing is for coupling, and a second depressing is for releasing.

R.O.C. patent publication No. 568197 discloses a clipping apparatus which includes an anchor seat and a sliding seat. The anchor seat has a housing trough for housing an elastic U-shaped action bar and a spring on the bottom. The sliding seat has an action plate slidable in the housing trough. The action bar has two opposing suspension ends interacting with two bosses extended from two sides of the action plate through the returning elastic force of the spring. Thereby the sliding seat can be maintained on a selected position. The clipping apparatus thus formed can be operated by depressing.

The patent set forth above also discloses a prior art (FIGS. 11 through 14) of a clipping apparatus which has a case and a clipping element slidable in the case. The clipping element can slide in, the case to form a clamping action to provide clipping function.

R.O.C. patent publication No. M269369 discloses a depressing clipping apparatus which provides holding and clipping function through a cyclic operation accomplished by depressing twice. It has a seat and a sliding seat. The seat has a hollow housing space to hold the sliding seat. The sliding seat has a base and a retaining portion on the bottom of the base. The base further has one side coupled with a clipping portion which is movable in a fan type. The retaining portion and the clipping portion form a clipping space between them.

As previously discussed, clipping apparatus is an indispensable element in many devices. Its stability and life span are important factors to be considered when they are being used.

### SUMMARY OF THE INVENTION

The primary object of the present invention is to solve the disadvantages of the conventional clipping apparatus. The present invention includes a seat which has a housing trough to hold a sliding member. The sliding member is movable in the housing trough to a first position in normal conditions and a second position in a depressed condition. The sliding member has a pawl which includes an upper clipping end and a lower clipping end. The lower clipping end can synchronously drive the upper clipping end through a coupling portion when subject to a force at an initial stage to form a first fan type moving track. The lower clipping end is in contact with the sliding member and moved vertically under the force to the second position, and drives the upper clipping end to form a second fan type moving track. Thereby the upper and lower clipping ends form a clipping space when the sliding member is on the second position to clip a desired article.

Another object of the present invention is to enhance clipping accuracy of the clipping apparatus. The apparatus has a flexible coupling section to couple the upper and lower clipping ends. Therefore, when the pawl and article to be clipped are not precisely aligned in the clipping space, the flexible section can be moved flexibly so that the article can still be clipped securely

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention.

FIG. 2 is an exploded view of the present invention.

FIGS. 3A, 3B and 3C are schematic views of the present invention in operating conditions.

FIG. 4 is a schematic view of an embodiment of the present invention.

### DETAILED DESCRIPTION OF THE PREFERRED EMBODIMENTS

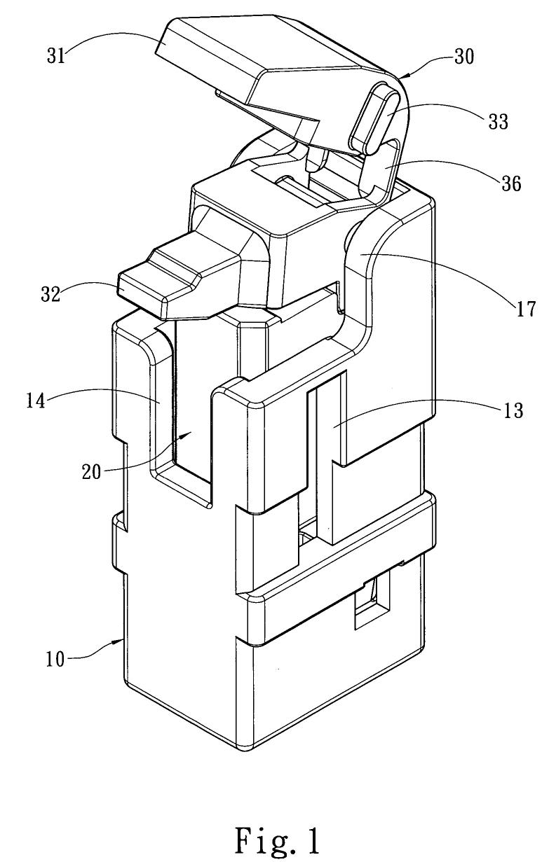

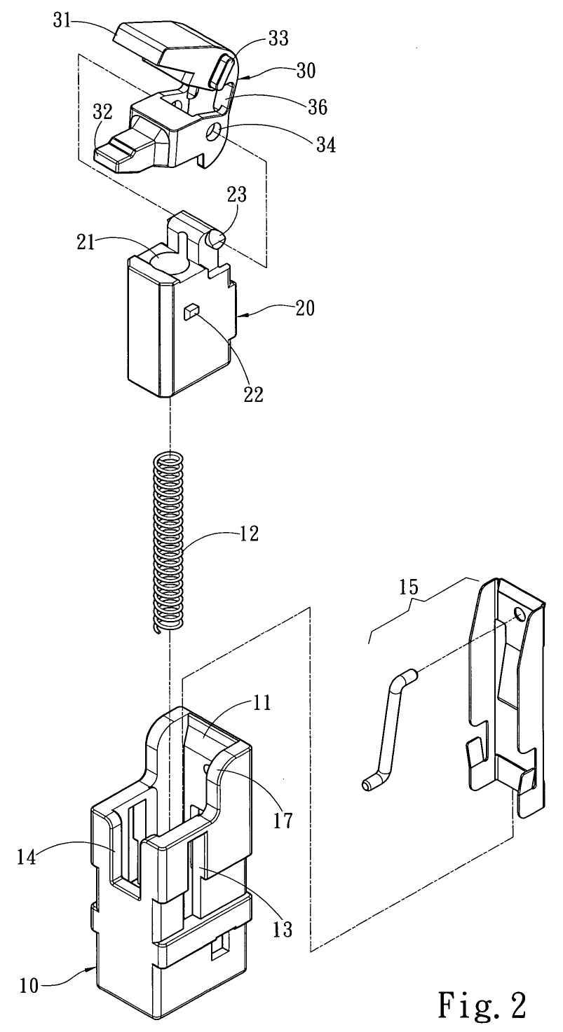

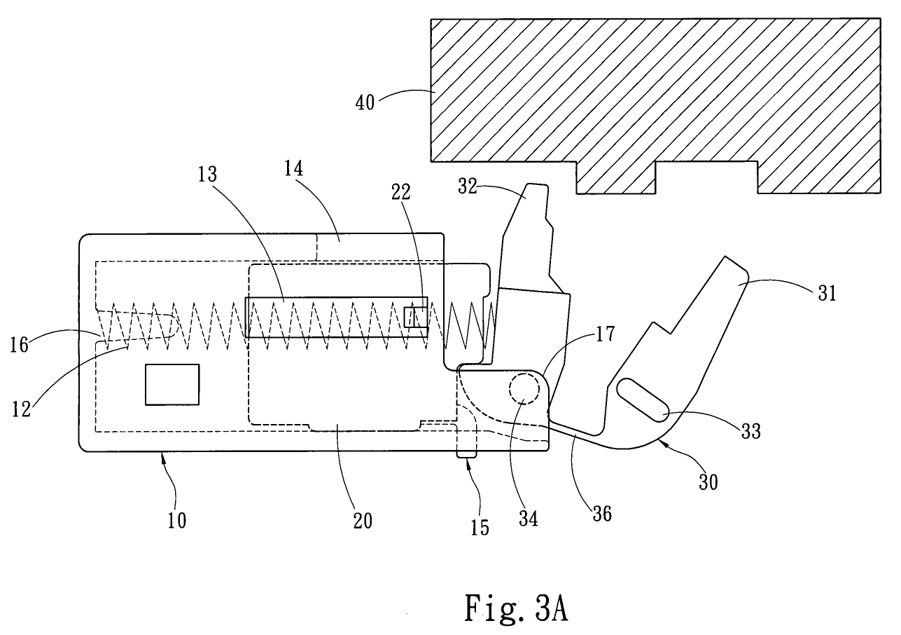

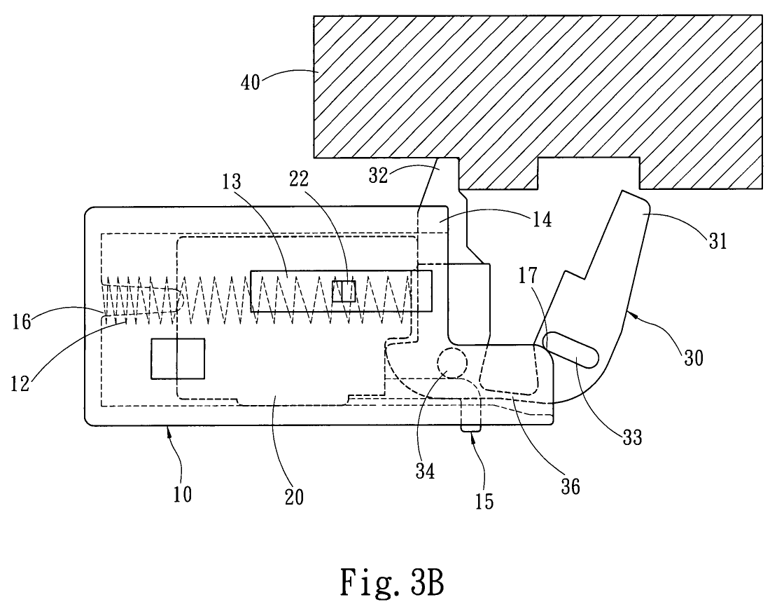

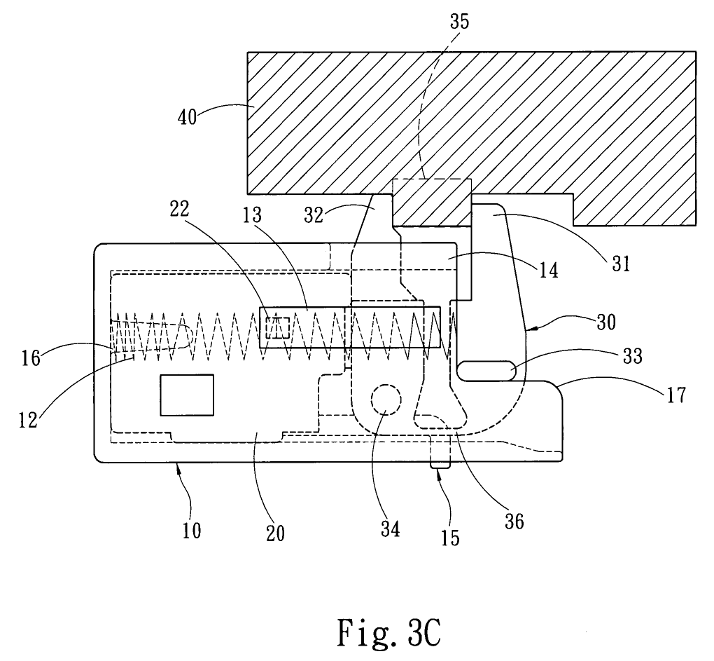

Please referring to FIGS. 1 and 2, the present invention includes a seat 10 which has a housing trough 11. The housing trough 11 houses an elastic element 12 (such as a spring) and a guiding member 15. The housing trough 11 also holds a sliding member 20 which has a through hole 21 to hold the elastic element 12. The elastic element 12 is coupled with the bottom of a lower clipping end 32 in normal conditions. In the event that the elastic element 12 is a spring, the seat 10 and the lower clipping end 32 have respectively an anchor boss 16 to hold the elastic element 12. The sliding member 20 is movable in the housing trough 11 through the elastic element 12 and the guiding member 15 to a first position in normal conditions, and a second position when depressed. To set the first and second position without exceeding a selected range, the seat 10 has a slot 13 to confine the movement of the sliding member 20 within the first and second positions. And the sliding member 20 has a lug 22 running through the slot 13 which confines the upper and lower limits of the lug 22 and the movement of the sliding member 20. The sliding member 20 further has a first coupling portion 23 to couple with a pawl 30 and a corresponding second coupling portion 34 located on the pawl 30. The drawings illustrate an embodiment of the first and second coupling portions 23 and 34 in which the first coupling portion 23 is a stub shaft on the sliding member 20 while the second coupling portion 34 is a corresponding pivot hole formed on the pawl 30. The pawl 30 has an upper clipping end 31 and the lower clipping end 32 that form a clipping space 35 (referring to FIG. 3C) to clip an article 40. The upper and lower clipping ends 31 and 32 are exposed outside the seat 10 through a corresponding displacement notch 14 formed thereon.

Referring to FIGS. 3A, 3B and 3C, when in use, the sliding member 20 has a detent member (not shown in the drawings) corresponding to the first and second positions to define a moving track of the guiding member 15. The guiding member 15 has one end located on the moving track so that the sliding member 20 can be anchored on the first and second positions through the guiding member 15 when the sliding member 20 is switched on the first and second positions. FIG. 3A shows the clipping apparatus is in a free condition. FIGS. 3B and 3C illustrate that the lower clipping end 32 receives a force at an initial stage and synchronously drives the upper clipping portion 31 through the coupling portions 23 and 34 to form a first fan type moving track. To aid the upper clipping end 31 to form the first fan type moving track, the upper clipping end 31 has a directing member 33 and the seat 10 has a corresponding guiding track 17. When the lower clipping end 32 is in contact with the sliding member 20 and moved vertically under force to the second position and drives the upper clipping end 31 to form the second fan type moving track, the upper and lower clipping ends 31 and 32 form the clipping space 35 on the second position to clip the article 40. FIG. 3C shows the clipping apparatus in a dead end position to clip the article 40.

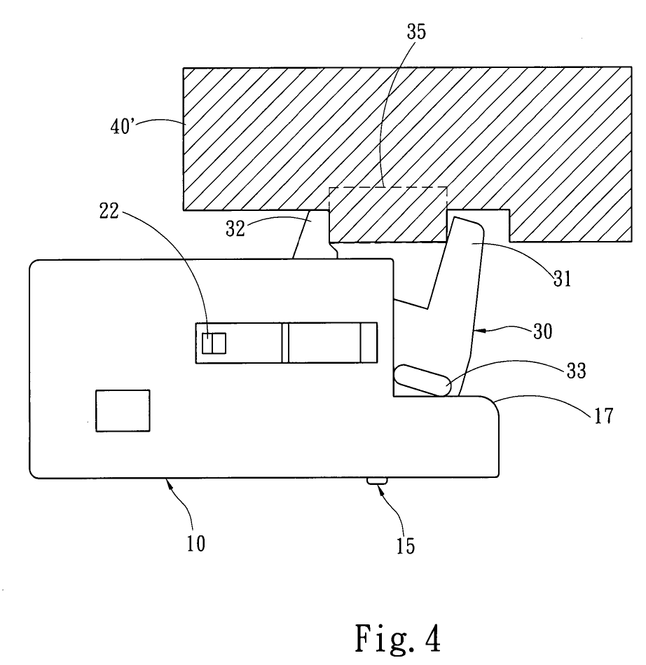

FIG. 3C depicts that the article 40 is clipped accurately and securely in an optimal condition in the clipping space 35 by the upper and lower clipping ends 31 and 32. Refer to FIG. 4 for an embodiment of the invention. An article 40′ is not exactly matched with the upper and lower clipping ends 31 and 32. But a coupling section 36 between the upper and lower clipping ends enables the upper clipping end 31 to be tilted slightly so that the article 40′ can still be clipped accurately and securely.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A sideward clipping apparatus, comprising:
a seat having a housing trough to hold an elastic element and a guiding member;
a sliding member located in the housing trough and movable in the housing trough through the elastic element and the guiding member to a first position in normal conditions and a second position when depressed, the sliding member having a coupling portion; and
a pawl having an upper clipping end and a lower clipping end, the lower clipping end synchronously driving the upper clipping end through the coupling portion at an initial force receiving state to form a first fan type moving track; and the lower clipping end being in contact with the sliding member and moved vertically to the second position under force to drive the upper clipping end to form a second fan type moving track thereby the upper clipping end and the lower clipping end form a clipping space on the second position to clip an article.

2. The sideward clipping apparatus of claim 1, wherein the seat has a guiding track and the pawl has a directing member corresponding to the guiding track to aid the upper clipping end to form the second fan type moving track.

3. The sideward clipping apparatus of claim 1, wherein the seat and the sliding member respectively have a slot and a corresponding lug to confine the sliding member to be moved to the first position and the second position.

4. The sideward clipping apparatus of claim 1, wherein the seat has a displacement notch to expose the upper and the lower clipping ends.

5. The sideward clipping apparatus of claim 1, wherein the sliding member has a detent member corresponding to the first and the second positions to define a moving track for the guiding member.

6. The sideward clipping apparatus of claim 1, wherein the upper and the lower clipping ends are connected through a coupling section.

7. The sideward clipping apparatus of claim 1, wherein the coupling portion includes a stub shaft on the sliding member and a pivot hole on the pawl corresponding to the stub shaft.

8. The sideward clipping apparatus of claim 1, wherein the elastic element runs through a through hole formed on the sliding member and presses the lower clipping end in the normal conditions.

9. The sideward clipping apparatus of claim 8, wherein the seat and the lower clipping end respectively have an anchor boss corresponding to the elastic element to anchor the elastic element.
